(19) United States
(12) Patent Application Publication
(10) Pub. No.: US 2010/0149100 A1
(43) Pub. Date: Jun. 17, 2010

(54) Electronic Devices, Systems, Methods and Computer Program Products for Detecting a User Input Device Having an Optical Marker Thereon

(75) Inventor: Linda Meiby, (US)

Correspondence Address: MYERS BIGEL SIBLEY & SAJOVEC, P.A., P.O. BOX 37428, RALEIGH, NC, 27627, US

(73) Assignee: Sony Ericsson Mobile Communications AB

(21) Appl. No.: 12/334,865

(22) Filed: Dec. 15, 2008

(51) Int. Cl. G06F 3/02

(52) U.S. Cl. 345/168

(57) ABSTRACT

An electronic device includes a user input display having a plurality of input keys on the input display. Each of the plurality of input keys corresponds to an input function for the input display. An optical detector is configured to detect optical data including a user input device. The user input device has an optical marker thereon. A user input management system is coupled to the user input display and the optical detector. The user input management system is configured to receive optical data from the optical detector, to identify a location of the optical marker of the user input device with respect to the user input display based on the optical data, and to identify a selected one of the plurality of input keys on the display responsive to the location of the optical marker.

### BACKGROUND

The present invention relates to electronic devices and, more particularly, to user interfaces for electronic devices, and methods and computer program products for providing user interfaces for electronic devices.

Many electronic devices, such as wireless communication terminals (e.g., cellular telephones), personal digital assistants (PDAs), palmtop computers, and the like, include monochrome and/or color display screens that may be used to display webpages, images and videos, among other things. Portable electronic devices may also include Internet browser software that is configured to access and display Internet content. Thus, these devices can have the ability to access a wide range of information content, including information content stored locally and/or information content accessible over a network such as the Internet.

As with conventional desktop and laptop computers, portable electronic devices have been provided with graphical user interfaces that allow users to manipulate programs and files using graphical objects, such as screen icons. Selection of graphical objects on a display screen of a portable electronic device can be cumbersome and difficult, however. Early devices with graphical user interfaces typically used directional keys and a selection key that allowed users to highlight and select a desired object. Such interfaces can be slow and cumbersome to use, as it may require several button presses to highlight and select a desired object.

More recent devices have employed touch sensitive screens that permit a user to select a desired object by pressing the location on the screen at which the object is displayed. However, such devices have certain drawbacks in practice. For example, the digitizer of a touch screen can “drift” over time, so that the touch screen can improperly interpret the location that the screen was touched. Thus, touch screens may have to be recalibrated on a regular basis to ensure that the digitizer is properly interpreting the location of touches.

Furthermore, while the spatial resolution of a touch screen can be relatively high, users typically want to interact with a touch screen by touching it with a fingertip. Thus, the size of a user's fingertip limits the actual available resolution of the touchscreen, which means that it can be difficult to manipulate small objects or icons on the screen, particularly for users with large hands. System designers are faced with the task of designing interfaces that can be used by a large number of people, and thus may design interfaces with icons larger than necessary for most people. Better touch resolution can be obtained by using a stylus instead of a touch screen. However, users may not want to have to use a separate instrument, such as a stylus, to interact with their device.

### SUMMARY

An electronic device according to some embodiments of the present invention includes a user input display having a plurality of input keys on the input display. Each of the plurality of input keys corresponds to an input function for the input display. An optical detector is configured to detect optical data including a user input device. The user input device has an optical marker thereon. A user input management system is coupled to the user input display and the optical detector. The user input management system is configured to receive optical data from the optical detector, to identify a location of the optical marker of the user input device with respect to the user input display based on the optical data, and to identify a selected one of the plurality of input keys on the display responsive to the location of the optical marker.

In some embodiments, the user input display further includes a touch-sensitive display configured to detect touch-sensitive data when the user input device contacts the user input display. The user input management system is further configured to receive touch-sensitive data from the touch-sensitive display unit, to correlate the optical data and the touch-sensitive data and to identify the selected one of the plurality of input keys on the display responsive to the touch-sensitive data and the location of the optical marker.

In some embodiments, the user input device is a finger and the user input marker has a contrasting color and/or brightness that optically distinguishes the marker from the user input device. The user input marker can be positioned in a central region of the user input device. In some embodiments, the user input marker is connected to a sleeve and/or glove configured to attach the user input marker to a finger of a user.

In some embodiments, the user input management system is configured to visually enlarge a selected one of the plurality of input keys based on the location of the user input marker. The user input management system can be configured to identify the user input marker based on a contrasting color and/or brightness between the user input marker and the user input device.

In some embodiments, methods for operating a hand-held electronic device by detecting an input on a user input display are provided. A user input display having a plurality of input keys on the input display is provided. Each of the plurality of input keys correspond to an input function for the input display. A user input device is optically detected using an optical detector configured to detect optical data including the user input device. The user input device has an optical marker thereon. A location of the optical marker of the user input device is identified with respect to the user input display based on the optical data. A selected one of the plurality of input keys on the display is identified responsive to the location of the optical marker.

In some embodiments, touch-sensitive data is detected when the user input device contacts the user input display. The optical data and the touch-sensitive data are correlated to identify the selected one of the plurality of input keys on the display responsive to the touch-sensitive data and the location of the optical marker.

In some embodiments, the user input device is a finger and the user input marker has a contrasting color and/or brightness that optically distinguishes the marker from the user input device. The user input marker can be positioned in a central region of the user input device.

In some embodiments, the user input marker is connected to a sleeve and/or glove configured to attach the user input marker to a finger of a user.

In some embodiments, a selected one of the plurality of input keys is visually enlarged based on the location of the user input marker.

In some embodiments, the user input marker is identified based on a contrasting color and/or brightness between the user input marker and the user input device.

A computer program product for operating a hand-held electronic device by detecting a user input on a user input display is provided according to some embodiments. The user input display has a plurality of input keys on the input display. Each of the plurality of input keys correspond to an input function for the input display. The computer program product includes a computer readable storage medium having computer readable program code embodied in the medium. The computer readable program code includes computer readable program code configured to optically detect a user input device using an optical detector. The user input device has an optical marker thereon. Computer readable program code is configured to identify a location of the optical marker of the user input device with respect to the user input display based on the optical data. Computer readable program code is configured to identify a selected one of the plurality of input keys on the display responsive to the location of the optical marker.

In some embodiments, computer readable program code is configured to detect touch-sensitive data when the user input device contacts the user input display, and computer readable program code is configured to correlate the optical data and the touch-sensitive data to identify the selected one of the plurality of input keys on the display responsive to the touch-sensitive data and the location of the optical marker.

In some embodiments, computer readable program code is configured to detect the user input marker when the user input marker is positioned in a central region of the user input device.

In some embodiments, computer readable program code is configured to visually enlarge a selected one of the plurality of input keys based on the location of the user input marker.

In some embodiments, computer readable program code is configured to identify the user input marker based on a contrasting color and/or brightness between the user input marker and the user input device.

Other systems, methods, and/or computer program products according to embodiments of the invention will be or become apparent to one with skill in the art upon review of the following drawings and detailed description. It is intended that all such additional systems, methods, and/or computer program products be included within this description, be within the scope of the present invention, and be protected by the accompanying claims.

### BRIEF DESCRIPTION OF THE DRAWINGS

The accompanying drawings, which are included to provide a further understanding of the invention and are incorporated in and constitute a part of this application, illustrate certain embodiment(s) of the invention. In the drawings:

FIG. 1 is front view of an electronic device, such as a portable electronic device, according to some embodiments of the present invention.

FIG. 2 is a side view of the electronic device of FIG. 1 and a user input device according to some embodiments of the present invention.

FIG. 3 is a front view of a keypad display of the electronic device of FIG. 1 illustrating some operations that can be performed according to some embodiments of the present invention.

FIG. 4 is a schematic diagram of a user input management system, an operating system and application programs in an electronic device configured according to some embodiments of the invention.

FIG. 5 is a flowchart illustrating operations in accordance with some embodiments of the present invention.

FIG. 6 a portable electronic device according to some embodiments of the present invention.

### DETAILED DESCRIPTION OF EMBODIMENTS OF THE INVENTION

The present invention now will be described more fully with reference to the accompanying drawings, in which embodiments of the invention are shown. However, this invention should not be construed as limited to the embodiments set forth herein. Rather, these embodiments are provided so that this disclosure will be thorough and complete, and will fully convey the scope of the invention to those skilled in the art. Like numbers refer to like elements throughout.

As used herein, the term “comprising” or “comprises” is open-ended, and includes one or more stated features, elements, steps, components or functions but does not preclude the presence or addition of one or more other features, elements, steps, components, functions or groups thereof. As used herein, the term “and/or” includes any and all combinations of one or more of the associated listed items. The terminology used herein is for the purpose of describing particular embodiments only and is not intended to be limiting of the invention. As used herein, the singular forms “a,” “an” and “the” are intended to include the plural forms as well, unless the context clearly indicates otherwise.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of this disclosure and the relevant art and will not be interpreted in an idealized or overly formal sense unless expressly so defined herein.

It will be understood that when an element is referred to as being “coupled” or “connected” to another element, it can be directly coupled or connected to the other element or intervening elements may also be present. In contrast, when an element is referred to as being “directly coupled” or “directly connected” to another element, there are no intervening elements present. Furthermore, “coupled” or “connected” as used herein may include wirelessly coupled or connected.

The present invention may be embodied as methods, electronic devices, and/or computer program products. Accordingly, the present invention may be embodied in hardware (e.g. a controller circuit or instruction execution system) and/or in software (including firmware, resident software, micro-code, etc.), which may be generally referred to herein as a “circuit” or “module.” Furthermore, the present invention may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can electronically/magnetically/optically retain the program for use by or in connection with the instruction execution system, apparatus, controller or device.

Embodiments according to the present invention are described with reference to block diagrams and/or operational illustrations of methods and communication terminals. In this regard, each block may represent a module, segment, or portion of code, which comprises one or more executable instructions for implementing the specified logical function(s). It is to be understood that each block of the block diagrams and/or operational illustrations, and combinations of blocks in the block diagrams and/or operational illustrations, can be implemented by radio frequency, analog and/or digital hardware, and/or program instructions. These program instructions may be provided to a controller, which may include one or more general purpose processors, special purpose processors, ASICs, and/or other programmable data processing apparatus, such that the instructions, which execute via the controller and/or other programmable data processing apparatus, create means for implementing the functions/acts specified in the block diagrams and/or operational block or blocks. In some alternate implementations, the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved.

These computer program instructions may also be stored in a computer-usable or computer-readable memory that may direct a computer or other programmable data processing apparatus to function in a particular manner, such that the instructions stored in the computer usable or computer-readable memory produce an article of manufacture including instructions that implement the function specified in the flowchart and/or block diagram block or blocks.

The computer-usable or computer-readable medium may be, for example but not limited to, an electronic, magnetic, optical, electromagnetic, or semiconductor system, apparatus, or device. More specific examples (a nonexhaustive list) of the computer-readable medium include the following: hard disks, optical storage devices, magnetic storage devices, a portable computer diskette, a random access memory (RAM), a read-only memory (ROM), an erasable programmable read-only memory (EPROM or Flash memory), and a compact disc read-only memory (CD-ROM).

An electronic device can function as a communication terminal that is configured to receive/transmit communication signals via a wireline connection, such as via a public-switched telephone network (PSTN), digital subscriber line (DSL), digital cable, or another data connection/network, and/or via a wireless interface with, for example, a cellular network, a satellite network, a wireless local area network (WLAN), and/or another communication terminal.

An electronic device that is configured to communicate over a wireless interface can be referred to as a “wireless communication terminal” or a “wireless terminal.” Examples of wireless terminals include, but are not limited to, a cellular telephone, personal data assistant (PDA), pager, and/or a computer that is configured to communicate data over a wireless communication interface that can include a cellular telephone interface, a Bluetooth interface, a wireless local area network interface (e.g., 802.11), another RF communication interface, and/or an optical/infra-red communication interface.

A portable electronic device may be portable, transportable, installed in a vehicle (aeronautical, maritime, or land-based), or situated and/or configured to operate locally and/or in a distributed fashion at any other location(s) on earth and/or in space. By “handheld” mobile terminal, it is meant that the outer dimensions of the mobile terminal are adapted and suitable for use by a typical operator using one hand. According to some embodiments, the total volume of the handheld mobile terminal is less than about 200 cc. According to some embodiments, the total volume of the handheld terminal is less than about 100 cc. According to some embodiments, the total volume of the handheld mobile terminal is between about 50 and 100 cc. According to some embodiments, no dimension of a handheld mobile terminal exceeds about 200 mm.

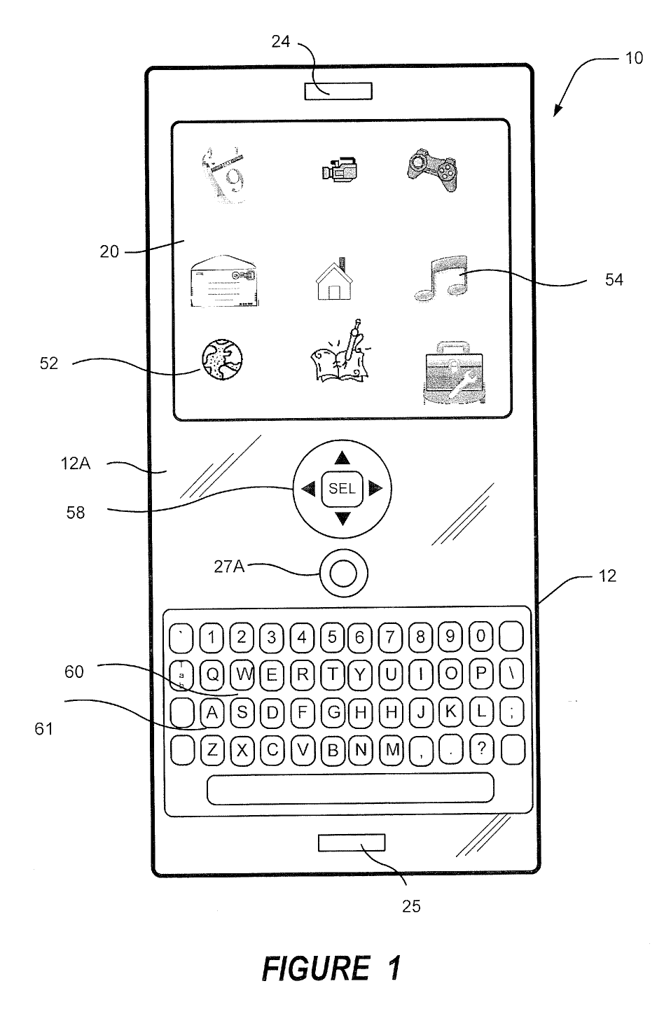

Some embodiments of the present invention will now be described below with respect to FIGS. 1-6. Some embodiments of the invention may be particularly useful in connection with a portable or handheld electronic device which may have more limited user input capability than a conventional desktop/laptop computer.

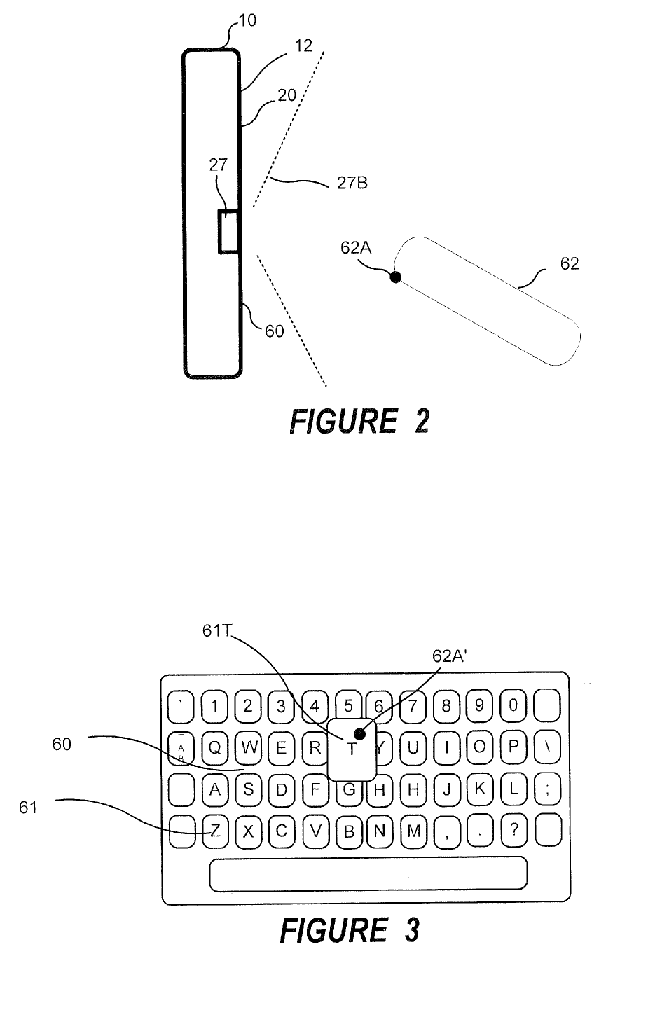

FIGS. 1-2 illustrate a portable or hand-held electronic device 10 according to some embodiments. The portable electronic device 10 includes a housing 12 including a front side 12A on which a user input display or screen 20 and another user input display or alphanumeric keypad 60 is provided. The front side also includes a set of selection keys 58 including direction keys (i.e., up (▴), down (▾), left ( [symbol] ), and right ( [symbol] )) and a select key (SEL).

As illustrated in FIG. 1, a number of objects 52, such as icons 54, can be displayed on the display screen 20. Each icon can represent an application program, a utility program, a command, a file, and/or other types of objects stored on and/or accessible by the device 10. A user can access a desired program, command, file, etc., by selecting the corresponding icon. For example, an icon can be selected by highlighting the icon using the direction keys and selecting the highlighted icon using the select (SEL) key. Alternative methods of selecting a desired object, such as an icon, on the display screen 20 are described below. As illustrated in FIG. 1, the alphanumeric keypad 60 may include a standard QWERTY keyboard with input keys 61. However, it will be understood that the alphanumeric keypad 60 could include any suitable arrangement of input keys, such as a standard 10 digit numeric keypad in which the keys 2-9 are also used for alpha input.

In some embodiments, the icons 54 and input keys 61 are soft keys that can be reconfigured and displayed on the display 20 or keypad 60, respectively, in more than one arrangement. In particular embodiments, the display 20 and/or keypad 60 includes a touch-sensitive display.

As illustrated in FIGS. 1-2, the device 10 includes a lens 27A of an optical detector, such as a camera 27, that is mounted adjacent the keypad 60. The camera 27 is configured to detect optical data within a field of view 27B including a user input device 62 having an optical marker 62A thereon. In some embodiments, the user input device 62 is a finger of a user, and the optical marker 62A is has a contrasting color or brightness compared to the user input device 62. For example, the marker 62A can be a colored ball or other object on a contrasting sleeve or glove that can be worn on the finger of the user. However, any suitable marker 62A can be used, such as a pigment (e.g., ink) applied directly to the finger or user input device 62. In some embodiments, the marker 62A can be an identified position on the user's finger or fingerprint, e.g., obtained using image recognition techniques.

Moreover, the camera 27 can be mounted in any suitable position to detect the user input device 62 within the field of view 27B to detect optical input to the keypad 60, and in some embodiments, more than one camera can be used to detect the user input device 62 and optical marker 62A. In some embodiments, an optical detector can be integrated within the screen 20 and/or keypad 60 to optically detect the user input device 62. It will be further appreciated that while the camera 27 is shown as integrated within the housing 12, the camera 27 can be separate from the housing 12 and can communicate with the electronic device 10 wirelessly and/or over a wired interface.

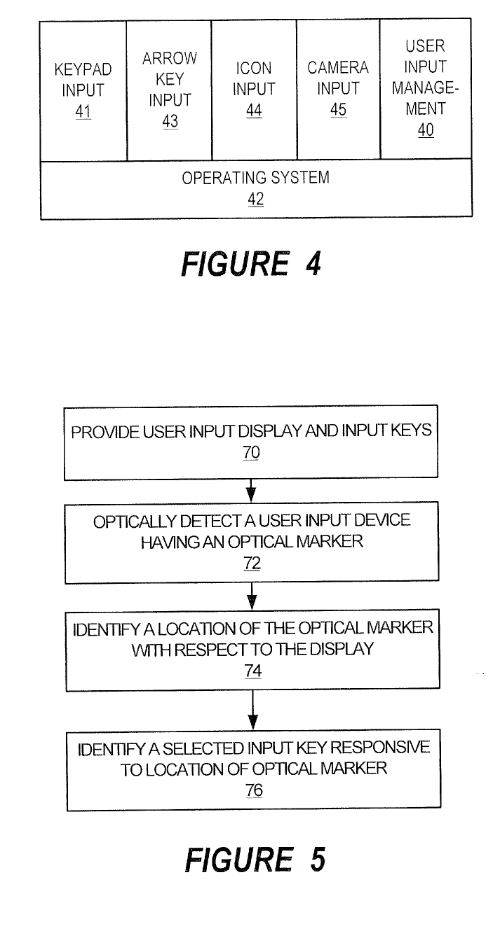

According to some embodiments, the electronic device 10 further includes a user input management system 40 (FIG. 4). The user input management system 40 may be configured to receive and process inputs received through the screen 20 or keypad 60 (including touch-sensitive data), the selection keys 58 and/or input received through images captured by the camera 27.

As shown in FIG. 4, the user input management system 40 may be implemented as a software module that runs on an operating system 42 of the portable electronic device 10. The operating system 42 also runs application software such as a keypad input module 41 (which receives data from the keypad 60), a selection key input module 43 (which receives data from the selection key 58), an icon input module 44 (which receives data from the screen 20) and/or a camera input module 45 (which receives data from the camera 27). Thus, in some embodiments, the user input management system 40 may process user input from the keypad 60, selection key 58, the screen 20 and/or the camera 27 for more than one application program running in the portable electronic device 10. The operating system 42 can also be configured to run various other application programs, such as internet browsers, communication programs, and other multimedia rendering application programs. The user input management system 40 may be configured to determine which application program is active when user input is received from the modules 41, 43, 44 and 45, and to forward user input commands to the currently active application.

In particular, the user input management system 40 can recognize features of the user input device 62, such as the marker 62A. In some embodiments as shown in FIG. 3, an image 62A′ of the marker 62A of FIG. 2 can be superimposed onto the keypad 60 or display 20, and the movement of the marker 62A can be interpreted as selection pointers by the user input management system 40, e.g., to select one of the keys 61A. In some embodiments as shown in FIG. 3, the user input management system 40 is configured to enlarge an input key 61T that overlaps with the image 62A′ of the marker 62A, e.g., to provide the user with a visual representation of the key 61T that may be selected. The keypad 60 can include a touch-sensitive display unit configured to detect touch-sensitive data, such as when the user input device 62 touches the keypad 60. It should be appreciated that the user input management system 40 can similarly recognize and interpret the marker 62A with respect to inputs on the display 20, e.g., to select or manipulate icons. Accordingly, the user input management system 40 can receive touch-sensitive data from the keypad 60 or display 20 and correlate the optical data and the touch-sensitive data to identify a desired input, such as a selected input key 61 or icon 54.

In this configuration, the user's finger can act as a pointing object, and the marker 62A can provide control and/or precision for using smaller keys than would be typically used in a touch-sensitive screen. In some embodiments, a full QWERTY keyboard as illustrated with respect to the keypad 60 can be provided in a significantly smaller space than can be typically used with a touch sensitive screen. For example, a typical finger tip can be about 12-18 mm in diameter. In some embodiments, the optical marker can have a diameter of about 0.5-3.0 mm. Accordingly, the input resolution can be about 5-25 times higher.

Although some embodiments are described with respect to the user input device 62 as a user's finger, it should be understood that other pointing objects, such as prosthetic devices or a stylus, can be used.

To facilitate recognition of the user's hand, it may be desirable for the camera 27 to be configured with a relatively wide field of view 27B (FIG. 2), a relatively short focal length and/or a relatively short depth of field (DOF) while operating in a control mode, so that objects in the background appear out of focus, while an object, such as the user's finger, that is held closer to the lens 27A, can remain in focus. Furthermore, the device 10 can be configured to automatically set the DOF to a desired level when entering the control mode. It will be appreciated that DOF can be affected by a number of aspects of camera design and configuration, including aperture size, focal length and magnification. Configuration of a camera to have a desired DOF at a desired focal distance is within the ordinary skill of a camera designer. In some embodiments, the device 10 can recognize the presence of fingertips in the camera view, and can adjust the camera settings as desired to facilitate image recognition. In particular embodiments, the camera 27 can be a relatively low resolution, camera that can be configured to identify a color and/or brightness contrast between the marker 62A and the user input device 62. For example, a camera having a resolution of less than one megapixel or less than 0.5 megapixels can be used. However, in some embodiments, higher resolution cameras can be used, for example, at 12 megapixels or more to identify a point on the fingerprint of the user as a marker. In some embodiments, the camera can have good contrast detection, darkness management and/or close object detection.

In some embodiments, the camera 27 can be configured to image infrared heat signals, so that the heat signal from a user's finger can be used to generate a thermal image that can be easily distinguished from background heat noise.

Object recognition techniques are well known to those skilled in the art and can be used to recognize the presence of a user's finger within the field of view 27B of the camera 27 and track the motion of the user's finger 62 and marker 62A within the field of view 27B.

Accordingly, the user input management system 40 can be configured to recognize the presence of a pointing object, such as a user's finger or input unit 62, within the field of view 27B of the camera 27. In some embodiments, the user input management system 40 can superimpose an object representative of the input unit 62 onto the display screen. For example, the user input management system 40 can display an arrow shaped object that is representative of the imaged marker 62A. It will be appreciated that when the image of the pointing marker 62A is superimposed onto the display screen 20 or on the keypad 60, it can be displayed above or below icons or objects displayed on the display screen 20 or on the keypad 60 from the perspective of a user looking at the display screen 20 and/or keypad 60.

While the portable electronic device 10 is illustrated in FIGS. 1 and 2 as a one piece, non-flip-type cellular telephone (e.g., “candy bar”), it will be appreciated that the device can be a clamshell-type flip phone including an upper housing rotatably attached to a lower housing, a slider-type telephone in which a main housing is slidably attached to an auxiliary housing, or any other structural design.

As a further example, a mobile device configured according to some embodiments can act as a wireless mouse that can control a remote device. For example, the device 10 can track the motion of the marker 62A with the camera 27 and translate movements of the marker 62A into mouse movements and/or mouse commands, but instead of displaying the marker 62A on the screen 20, the actual commands as well as mouse coordinates corresponding to the location and/or movement of the marker 62A can be sent to the remote device.

Other possible applications of embodiments of the invention include controlling a menu on a television set, sorting pictures on a server using a television monitor as a display, etc.

Operations according to some embodiments are illustrated in FIG. 5. A user input display having a plurality of input keys on the input display is provided (Block 70). Each of the plurality of input keys correspond to an input function for the input display. A user input device is detected using an optical detector configured to detect optical data including the user input device (Block 72). The user input device has an optical marker thereon. A location of the optical marker of the user input device is identified with respect to the user input display based on the optical data (Block 74). A selected one of the plurality of input keys is identified on the display responsive to the location of the optical marker.

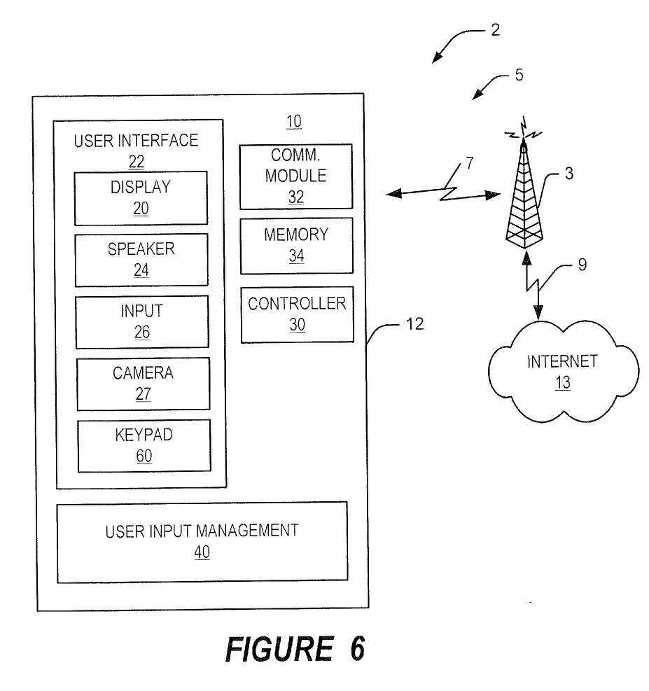

Referring to FIG. 6, an exemplary electronic device 10 in accordance with some embodiments of the present invention is illustrated. It will be appreciated that although embodiments of the invention are illustrated in connection with a wireless communication terminal, the invention may include wired mobile and/or non-mobile communication terminals and other electronic devices and methods. The portable electronic device 10 can be configured to communicate data with one or more other wireless terminals over a direct wireless communication interface therebetween, over another wireless communication interface through one or more cellular base stations, and/or over another wireless communication interface through a wireless local area network (WLAN) router. It will be appreciated that the portable electronic device 10 need not be a cellular telephone, but could be any other type of portable electronic device that includes a display screen, such as a personal digital assistant (PDA), handheld GPS unit, or other type of electronic device.

The portable electronic device 10 may be a mobile radiotelephone forming a part of a radiotelephone communication system 2 as illustrated in FIG. 6. The system 2 includes the portable electronic device 10 and a base transceiver station 3, which is part of a wireless communications network 5. In some embodiments of the present invention, the base transceiver station 3 includes the radio transceiver(s) that define an individual cell in a cellular network and communicates with the portable electronic device 10 (via an interface 7) and other mobile terminals in the cell using a radio-link protocol. It will be understood that, in some embodiments of the present invention, many base transceiver stations may be connected through, for example, a mobile switching center and other devices to define the wireless communications network. The base station transceiver 5 may be connected to a data communications network 13, such as the Internet, via a communication link 9. It will be appreciated that the communication link 9 may include elements of the wireless communications network and/or one or more gateways, routers, or other communication nodes.

The portable electronic device 10 in the illustrated embodiments includes a portable housing assembly 12, a controller circuit 30 (“controller”), a communication module 32, and a memory 34. The portable electronic device 10 further includes a user interface 22 including a display screen 20, a keypad 60 and a camera 27. The user interface 22 can further include a speaker 24, and at one or more other input devices 26. The input device 26 may include a keyboard, which may be a numerical keyboard including keys that correspond to a digit as well as to one or more characters, such as may be found in a conventional wireless telephone. The device 10 includes a user input management system 40 that manages and interprets user inputs, for example, from the display screen 20, the keypad 60, and the camera 27 as described herein.

The camera 27 can include a digital camera having a CCD (charge-coupled device), CMOS (complementary MOS) or other type of image sensor, and can be configured to record still images and/or moving images and convert the images into a format suitable for display and/or manipulation.

The display screen 20 and/or keypad 60 may be any suitable display screen assembly. For example, the display screen 20 and/or keypad 60 may be a liquid crystal display (LCD) with or without auxiliary lighting (e.g., a lighting panel). In some cases the portable electronic device 10 may be capable of playing video content of a particular quality. For example, a portable electronic device 10 may be configured to display a video stream having a particular aspect ratio, such as 16:9 or 4:3. A number of standard video formats have been proposed for mobile terminals, including Quarter VGA (QVGA, 320×240 pixels), Common Intermediate Format (CIF, 360×288 pixels) and Quarter Common Intermediate Format (QCIF, 180×144 pixels). Moreover, some mobile terminals may have multiple display screens having different display capabilities. Thus, a portable electronic device 10 may be capable of displaying video in one or more different display formats.

The display screen 20 and/or keypad 60 can include a touch-sensitive display screen that is configured to detect touches and convert the detected touches into positional information that can be processed by the controller 30.

The user interface 22 may include any suitable input device(s) including, for example, a touch activated or touch sensitive device (e.g., a touch screen), a joystick, a keyboard/keypad, a dial, a directional key or keys, and/or a pointing device (such as a mouse, trackball, touch pad, etc.). The speaker 24 generates sound responsive to an input audio signal. The user interface 22 can also include a microphone 25 (FIG. 1) coupled to an audio processor that is configured to generate an audio data stream responsive to sound incident on the microphone 25.

The controller 30 may support various functions of the portable electronic device 10, and can be any commercially available or custom microprocessor. In use, the controller 30 of the portable electronic device 10 may generate and display an image on the display screen 20 and/or keypad 60. In some embodiments, however, a separate signal processor and/or video chip (not shown) may be provided in the portable electronic device 10 and may be configured to generate a display image on the display screen 20. Accordingly, the functionality of the controller 30 can be distributed across multiple chips/devices in the portable electronic device 10.

The memory 34 is configured to store digital information signals and data such as a digital multimedia files (e.g., digital audio, image and/or video files).

The communication module 32 is configured to communicate data over one or more wireless interfaces to another remote wireless terminal as discussed herein. The communication module 32 can include a cellular communication module, a direct point-to-point connection module, and/or a WLAN module.

The portable electronic device 10 can include a cellular communication module that allows the device 10 to communicate via the base transceiver station(s) 3 of the network 5 using one or more cellular communication protocols such as, for example, Advanced Mobile Phone Service (AMPS), ANSI-136, Global Standard for Mobile (GSM) communication, General Packet Radio Service (GPRS), enhanced data rates for GSM evolution (EDGE), code division multiple access (CDMA), wideband-CDMA, CDMA2000, and Universal Mobile Telecommunications System (UMTS). The cellular base stations may be connected to a Mobile Telephone Switching Office (MTSO) wireless network, which, in turn, can be connected to a PSTN and/or another network.

A direct point-to-point connection module may include a direct RF communication module or a direct IR communication module. The direct RF communication module may include a Bluetooth module. With a Bluetooth module, the portable electronic device 10 can communicate via an ad-hoc network through a direct point-to-point interface.

With a WLAN module, the wireless terminal 10 can communicate through a WLAN using a communication protocol that may include, but is not limited to, 802.11a, 802.11b, 802.11e, 802.11g, and/or 802.11i.

The communication module 32 can include a transceiver typically having a transmitter circuit and a receiver circuit, which respectively transmit outgoing radio frequency signals (e.g., to the network 5, a router or directly to another terminal) and receive incoming radio frequency signals (e.g., from the network 5, a router or directly to another terminal), such as voice and data signals, via an antenna. The communication module 32 may include a short range transmitter and receiver, such as a Bluetooth transmitter and receiver. The antenna may be an embedded antenna, a retractable antenna or any antenna known to those having skill in the art without departing from the scope of the present invention. The radio frequency signals transmitted between the portable electronic device 10 and the network 5, router or other terminal may include both traffic and control signals (e.g., paging signals/messages for incoming calls), which are used to establish and maintain communication with another party or destination. The radio frequency signals may also include packet data information, such as, for example, cellular digital packet data (CDPD) information. In addition, the transceiver may include an infrared (IR) transceiver configured to transmit/receive infrared signals to/from other electronic devices via an IR port.

The portable electronic device 10 may also be configured to electrically communicate with another terminal via a wireline or cable for the transmission of digital communication signals therebetween.

Although FIG. 6 illustrates an exemplary hardware/software architecture that may be used in mobile terminals and/or other electronic devices, it will be understood that the present invention is not limited to such a configuration but is intended to encompass any configuration capable of carrying out operations described herein. For example, although the memory 34 is illustrated as separate from the controller 30, the memory 34 or portions thereof may be considered as a part of the controller 30. More generally, while particular functionalities are shown in particular blocks by way of illustration, functionalities of different blocks and/or portions thereof may be combined, divided, and/or eliminated. Moreover, the functionality of the hardware/software architecture of FIG. 6 may be implemented as a single processor system or a multi-processor system in accordance with various embodiments of the present invention.

Furthermore, elements such as the camera 27 that are shown as integral to the device 10 can be separated from the device 10 with a communication path provided therebetween.

The foregoing is illustrative of the present invention and is not to be construed as limiting thereof. Although a few exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. Therefore, it is to be understood that the foregoing is illustrative of the present invention and is not to be construed as limited to the specific embodiments disclosed, and that modifications to the disclosed embodiments, as well as other embodiments, are intended to be included within the scope of the appended claims. The invention is defined by the following claims, with equivalents of the claims to be included therein.

That which is claimed is:

1. An electronic device comprising:
a user input display having a plurality of input keys on the input display, each of the plurality of input keys corresponding to an input function for the input display;
an optical detector configured to detect optical data comprising a user input device, wherein the user input device has an optical marker thereon; and
a user input management system coupled to the user input display and the optical detector, wherein the user input management system is configured to receive optical data from the optical detector, to identify a location of the optical marker of the user input device with respect to the user input display based on the optical data, and to identify a selected one of the plurality of input keys on the display responsive to the location of the optical marker.

2. The electronic device of claim 1, wherein the user input display further comprises a touch-sensitive display configured to detect touch-sensitive data when the user input device contacts the user input display, and wherein the user input management system is further configured to receive touch-sensitive data from the touch-sensitive display unit, to correlate the optical data and the touch-sensitive data and to identify the selected one of the plurality of input keys on the display responsive to the touch-sensitive data and the location of the optical marker.

3. The electronic device of claim 1, wherein the user input device comprises a finger and the user input marker has a contrasting color and/or brightness that optically distinguishes the marker from the user input device.

4. The electronic device of claim 1, wherein the user input marker is positioned in a central region of the user input device.

5. The electronic device of claim 1, wherein the user input marker is connected to a sleeve and/or glove configured to attach the user input marker to a finger of a user.

6. The electronic device of claim 1, wherein the user input management system is configured to visually enlarge a selected one of the plurality of input keys based on the location of the user input marker.

7. The electronic device of claim 1, wherein the user input management system is configured to identify the user input marker based on a contrasting color and/or brightness between the user input marker and the user input device.

8. A method for operating a hand-held electronic device by detecting an input on a user input display, the method comprising:
providing a user input display having a plurality of input keys on the input display, each of the plurality of input keys corresponding to an input function for the input display;
optically detecting a user input device using an optical detector configured to detect optical data comprising the user input device, wherein the user input device has an optical marker thereon;
identifying a location of the optical marker of the user input device with respect to the user input display based on the optical data; and
identifying a selected one of the plurality of input keys on the display responsive to the location of the optical marker.

9. The method of claim 8, further comprising:
detecting touch-sensitive data when the user input device contacts the user input display, and
correlating the optical data and the touch-sensitive data to identify the selected one of the plurality of input keys on the display responsive to the touch-sensitive data and the location of the optical marker.

10. The method of claim 8, wherein the user input device comprises a finger and the user input marker has a contrasting color and/or brightness that optically distinguishes the marker from the user input device.

11. The method of claim 8, further comprising positioning the user input marker in a central region of the user input device.

12. The method of claim 8, further comprising connecting the user input marker to a sleeve and/or glove configured to attach the user input marker to a finger of a user.

13. The method of claim 8, further comprising visually enlarging a selected one of the plurality of input keys based on the location of the user input marker.

14. The method of claim 8, further comprising identifying the user input marker based on a contrasting color and/or brightness between the user input marker and the user input device.

15. A computer program product for operating a hand-held electronic device by detecting a user input on a user input display, wherein the user input display has a plurality of input keys on the input display, each of the plurality of input keys corresponding to an input function for the input display, the computer program product comprising:
a computer readable storage medium having computer readable program code embodied in said medium, said computer readable program code comprising:
computer readable program code configured to optically detect a user input device using an optical detector, wherein the user input device has an optical marker thereon;
computer readable program code configured to identify a location of the optical marker of the user input device with respect to the user input display based on the optical data; and
computer readable program code configured to identify a selected one of the plurality of input keys on the display responsive to the location of the optical marker.

16. The computer program product of claim 15, further comprising:
computer readable program code configured to detect touch-sensitive data when the user input device contacts the user input display, and
computer readable program code configured to correlate the optical data and the touch-sensitive data to identify the selected one of the plurality of input keys on the display responsive to the touch-sensitive data and the location of the optical marker.

17. The computer program product of claim 15, further comprising computer readable program code configured to detect the user input marker when the user input marker is positioned in a central region of the user input device.

18. The computer program product of claim 15, further comprising computer readable program code configured to visually enlarge a selected one of the plurality of input keys based on the location of the user input marker.

19. The computer program product of claim 15, further comprising computer readable program code configured to identify the user input marker based on a contrasting color and/or brightness between the user input marker and the user input device.
